(19) United States
(12) Patent Application Publication
(10) Pub. No.: US 2009/0066685 A1
(43) Pub. Date: Mar. 12, 2009

(54) DRIVING AN IN-PLANE MOVING PARTICLE DEVICE

(76) Inventors: Murray Fulton Gillies, Eindhoven (GB); Alwin Rogier Martijn Verschueren, Eindhoven (NL); Mark Thomas Johnson, Eindhoven (NL); Martinus Hermanus Wilhelmus Maria Van Delden, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 12/280,382

(22) PCT Filed: Feb. 14, 2007
(86) PCT No.: PCT/IB07/50486

§ 371 Date: Aug. 22, 2008

(30) Foreign Application Priority Data
Feb. 27, 2006 (EP) 06110430.3

(51) Int. Cl. G09G 3/34

(52) U.S. Cl. 345/212

(57) ABSTRACT

An in-plane driven moving particle device comprises a first substrate (SUI) and an moving particle material (EM) comprising charged particles (PA), a first electrode (RE) and a second electrode (GE; DE), both arranged on the first substrate (SUI) for generating a predominantly in-plane electrical field in the moving particle material (EM), and a driver (DR). The driver (DR) supplies, during a transition phase wherein an optical state of the moving particle material (EM) has to change, a first voltage (VR) to the first electrode (RE), and a second voltage (VG; VD1) to the second electrode (GE; DE). Both the first voltage (VR) and the second voltage (VG; VD1) comprise a sequence of a plurality of predetermined levels having predetermined durations, and wherein the first voltage (VR) and/or the second voltage (VG; VD1) have a non-zero average level. The levels, durations and average level are selected for allowing the particles (PA) to move between the first electrode (RE) and second electrode (GE; DE) in opposite directions to change the optical state a plurality of times in opposite directions during the sequence, and to obtain a net movement of the particles during the transition phase in a direction of an electrical field caused by the average level.

The invention relates to a driver for an in-plane driven moving particle device, an in-plane driven moving particle device, a display apparatus comprising the device, and a method of driving an in-plane moving particle display.

U.S. Pat. No. 6,639,580 discloses a prior art in-plane electrophoretic display with a first display electrode, a control electrode and a second display electrode arranged on a same first substrate. The electrophoretic material is sandwiched between the first substrate and a second substrate. The control electrode is arranged in-between the first and the second display electrode. U.S. Pat. No. 6,639,580 discloses another prior art embodiment which does not have the control electrode in-between the first and the second display electrode but on the second substrate. The second display electrode is nearer to the second substrate than the first display electrode. However, this other prior art embodiment has a bad contrast, which is solved by U.S. Pat. No. 6,639,580 by adding to the first mentioned prior art in-plane electrophoretic display a second control electrode on the second substrate and by positioning the first control electrode nearer to the second substrate than the display electrodes.

It is an object of the invention to improve the contrast and/or brightness of the device with a simpler construction of the display.

A first aspect of the invention provides a driver for an in-plane driven moving particle device. A second aspect of the invention provides an in-plane driven moving particle device as claimed in claim 6. A third aspect of the invention provides a display apparatus comprising the in-plane driven moving particle device as claimed in claim 12. A fourth aspect of the invention provides a method of driving an in-plane moving particle device as claimed in claim 13. Advantageous embodiments are defined in the dependent claims.

The present invention is elucidated with respect to the in-plane driven moving particle device in accordance with the second aspect of the invention. From this elucidation it becomes clear how the driver in accordance with the first aspect of the invention reaches the object of the invention. The in-plane driven moving particle device comprises a first substrate and a material of which the optical state can be influenced by applying an electrical field to the material. The material may be an electrophoretic material in which charged particles are suspended. The charged particles move in a suspension if an electrical field is generated in the material. The charged particles substantially keep their position if no electrical field is present in the material. An example of an electrophoretic material is E-ink which usually comprises white and black particles. With in-plane driven is meant that the electrical field, which is generated in the moving particle material by supplying potential differences between the electrodes, is predominantly directed in parallel to the surface of the first substrate. The first and a second electrode may both be arranged directly on the first substrate. Alternatively, other layers, such as for example an insulating layer, may be present between the substrate and at least one of the first and the second electrodes. If a second substrate is present which opposes the first substrate, one of the electrodes may be provided on the second substrate at a position displaced in the in-plane direction with respect to the position of the other one of the electrodes on the first substrate. What counts is that the electrical field is directed predominantly in the in-plane direction, thus predominantly in parallel with the surface of the first substrate. In the now following the operation of the in-plane driven moving particle device is elucidated with respect to an electrophoretic material.

A driver supplies, during a transition phase wherein an optical state of the electrophoretic material has to change, a first voltage to the first electrode, and a second voltage to the second electrode. Both the first voltage and the second voltage comprise a sequence of a plurality of predetermined levels with predetermined durations. The first voltage and/or the second voltage have a predetermined average level. The levels, the duration and the average level are selected such that, on the one hand, the particles are moved between the first and second electrodes a plurality of times in opposite directions thereby changing the optical state in opposite directions, and, on the other hand, to obtain a net movement of the particles during the transition phase in a direction of an electrical field caused by the average level. In a display, the transition phase may be the reset phase wherein all pixel are reset to their initial optical state, or the writing phase wherein starting from the reset phase the optical states of the pixels are selectively changed. The sequence of levels may be referred to as pulses. The pulses may have a fixed or a variable duration during the transition phase. Instead or additionally, the pulses may have a fixed or a variable level during the transition phase. The average level may also be referred to as the DC-level.

In fact, the pulses on the first and the second electrodes, which are superimposed on the average offset voltage (also referred to as the DC offset) between the first and the second electrodes, improve the mobility of the particles such that they better respond to the electrical field generated by this DC offset. Consequently, the particle movement due to the DC offset will be more complete which improves the contrast and brightness of the electrophoretic device. Further, the final optical state can be reached within a shorter time because without the pulses the final optical state may in the end be reached by Brownian motion, but this is a very slow process.

US2004/0145696 discloses in one embodiment an in-plane electrophoretic display. The pixels comprise both negatively and positively charged particles and two in-plane arranged display electrodes. A drawback of the presence of both positively and negatively charged particles is that they aggregate to groups of particles. The display electrodes are covered by a piezo-electric material. The groups of particles are crushed by supplying a high frequent sine wave voltage between the display electrodes which activates the piezo element. The high frequency of the sine wave is intended to crush the particles and not to move the particles to change the optical state of the pixels.

It is known to supply shaking pulses to opposing electrodes of an electrophoretic display during periods in time preceding a reset period or a write period. In such an electrophoretic display, the electrical field is directed predominantly perpendicular to the surface of the substrates. These shaking pulses increase the mobility of the particles without changing the optical state of the pixels. The frequency of these pulses is so high (for example 50 Hz) that there is insufficient time in one period for the particles to move between the electrodes such that the optical state changes. Consequently, the optical state during each level of the pulses is substantially not affected. The timing of the pulses differs in that they do not occur during the application of the reset voltage level which resets all pixels to one of the limit optical states (black or white, if black and white particles are used) or the write voltage level which changes the optical state towards the desired state. Further, these shaking pulses are not superimposed on a DC-offset level.

In an embodiment as claimed in claim 3, the driver supplies the first voltage pulses and the second voltage pulses such that a direction of the electrical field between the first and the second electrode is inverted in successive ones of the levels of the first voltage pulses and the second voltage pulses. This has the effect that, during successive levels, the particles move between the first and second electrodes in opposite directions to change the optical state in opposite directions.

In an embodiment as claimed in claim 5, the driver is generates the levels of the first voltage and the levels of the second voltage such that a first electrical field caused by the levels when supplied for moving the particles in a direction of the net movement of the particles during the transition phase is smaller than a second electrical field caused by the levels when supplied for moving the particles in a direction opposite to the direction of the net movement. This high field in the opposite direction has the advantage that particles which stick to the electrodes will be loosened. It has to be noted that the average level of the voltage over the moving particle material should allow for the net movement. Consequently the relatively high voltage across the material to obtain the high field must have a relatively short duration with respect to the relatively low voltage across the material, which low voltage causes the smaller electrical field oppositely directed with respect to the high electrical field.

In an embodiment as claimed in claim 7, the in-plane driven moving particle device is an electrophoretic display. Preferably, the electrophoretic display comprises a second substrate opposing the first substrate, wherein the electrophoretic suspension is sandwiched in-between the first substrate and the second substrate, and wherein the first substrate and/or the second substrate is transparent. However, the present invention is not limited to a display, the electrophoretic device may also be used in components, such as, for example a micro-fluidic device containing biological particles or an optical shutter device.

In an embodiment as claimed in claim 9, in the in-plane driven moving particle device, the first electrode is a reservoir electrode and the second electrode is a gate electrode. The device further comprises a display electrode. The gate electrode is arranged in-between the reservoir electrode and the display electrode. The levels, the durations thereof and the average level of the first and the second voltage are selected for allowing the particles to cross the gate electrode. Alternatively, the first electrode may be the gate electrode and the second electrode may be the display electrode.

In an embodiment as claimed in claim 10, the driver increases a frequency of the pulses during the transition phase from a start value at which the particles have sufficient time to move between the first and the second electrode to an end value at which the particle movement is predominantly determined by the average level between the first and the second electrode.

In an embodiment as claimed in claim 11, the driver decreases an amplitude of the pulses during the transition phase from a start value at which the particles move between the first and the second electrode to an end value at which the particle movement is predominantly determined by the DC level between the first and the second electrode.

These and other aspects of the invention are apparent from and will be elucidated with reference to the embodiments described hereinafter.

In the drawings:

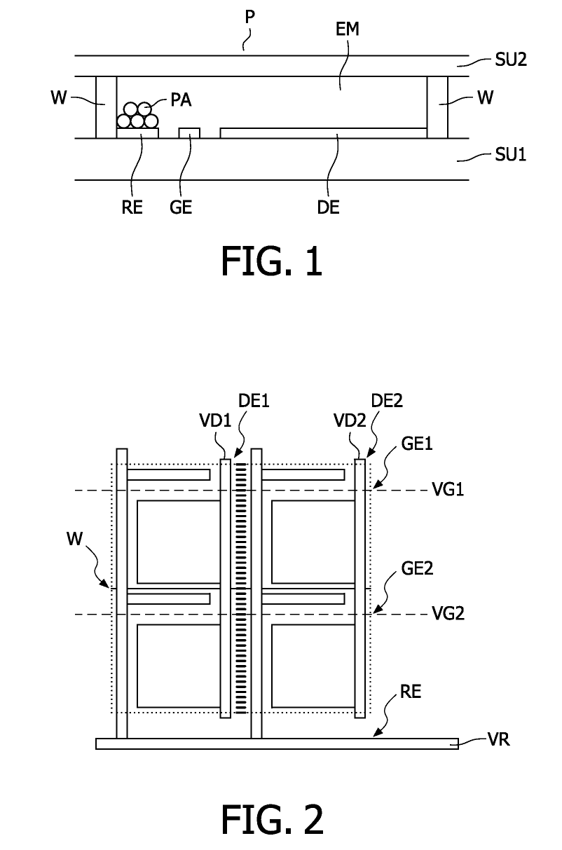

FIG. 1 shows schematically a cross section of a pixel of an in-plane passive electrophoretic display,

FIG. 2 shows schematically an electrode arrangement for four pixels of an in-plane electrophoretic passive matrix display,

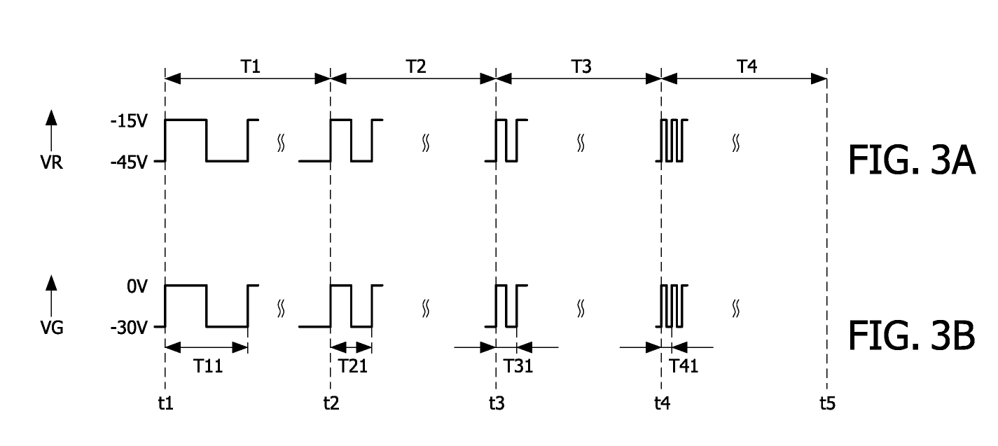

FIGS. 3A and 3B show signals for driving the electrodes of the in-plane electrophoretic display shown in FIG. 2,

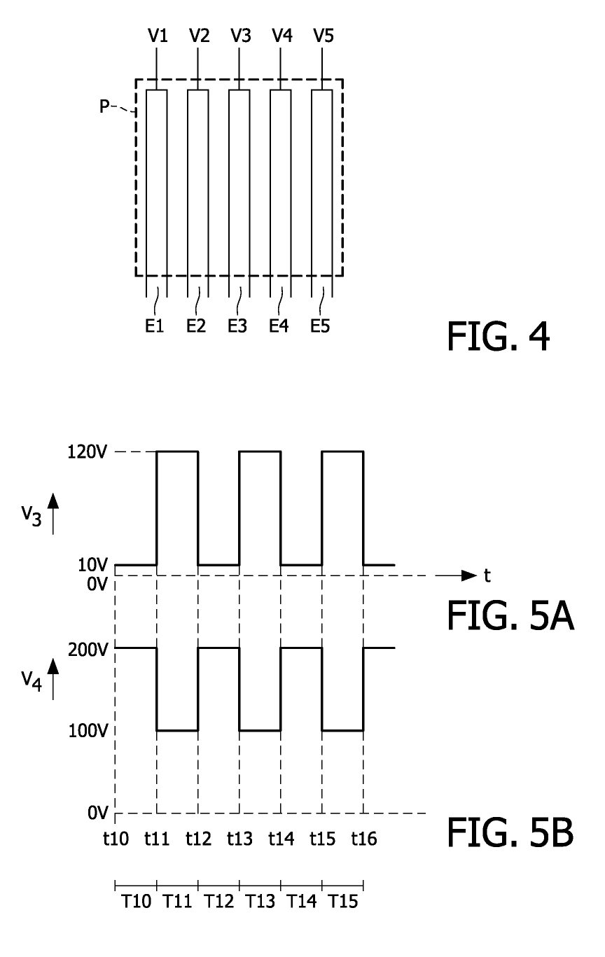

FIG. 4 shows schematically an electrode arrangement for a pixel of an in-plane electrophoretic display,

FIGS. 5A and 5B show signals for driving the electrodes of the in-plane electrophoretic display shown in FIG. 4,

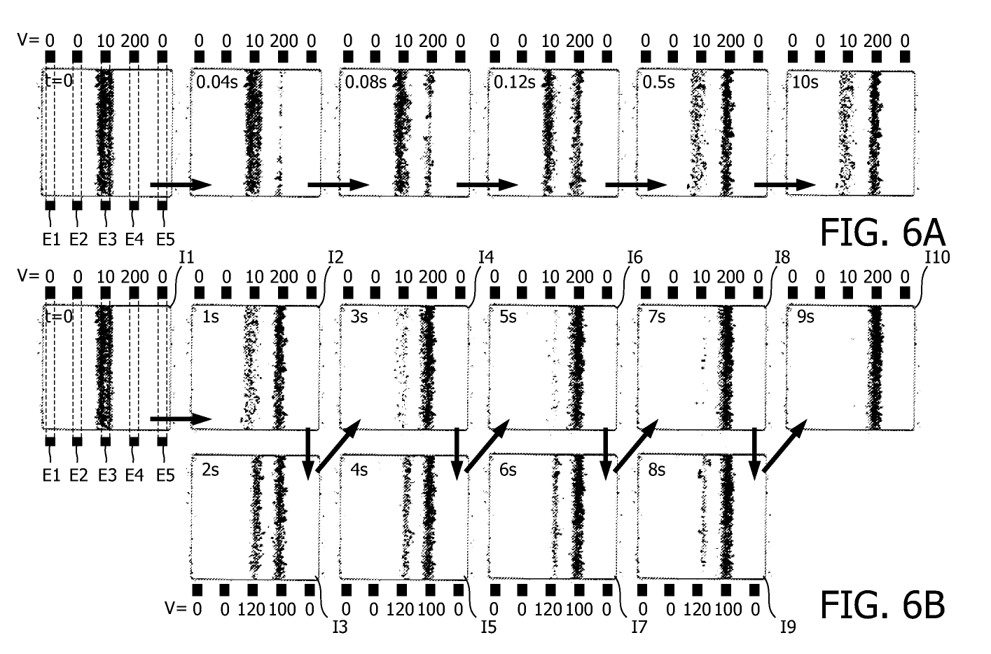

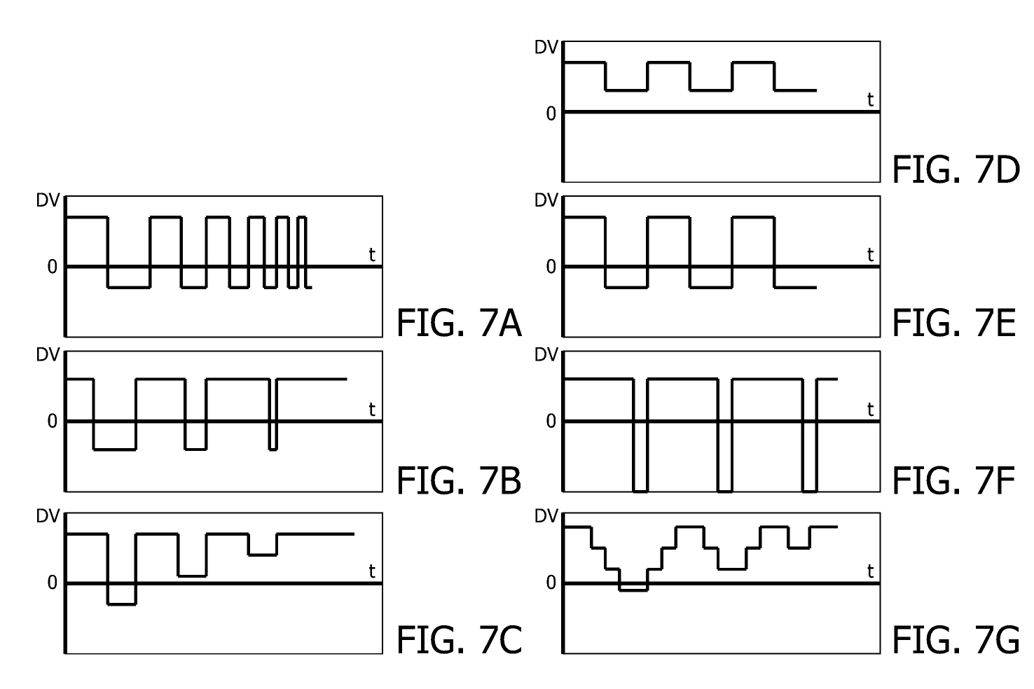

FIGS. 6A and 6B, respectively illustrate the movement of the particles in the display shown in FIG. 4 with a prior art drive and with a drive in accordance with the signals shown in FIGS. 5A and 5B,

FIGS. 7A to 7G show examples of the voltage difference between two electrodes in accordance with the present invention, and

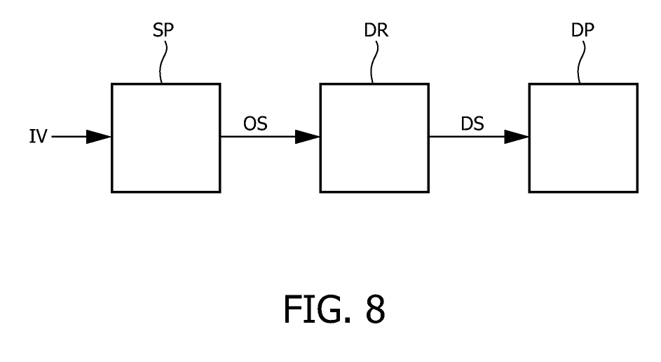

FIG. 8 shows a block diagram of a display apparatus.

It should be noted that items which have the same reference numbers in different Figures, have the same structural features and the same functions, or are the same signals. Where the function and/or structure of such an item has been explained, there is no necessity for repeated explanation thereof in the detailed description.

FIG. 1 shows schematically a cross section of a pixel of an in-plane electrophoretic passive matrix display. A reservoir electrode RE, a gate electrode GE and a display electrode DE are arranged directly or indirectly on top of the substrate SU1. The gate electrode GE is arranged in-between the reservoir electrode RE and the display electrode DE. The electrophoretic material EM is sandwiched between the substrates SU1 and SU2. The pixel P is bounded by walls W. The electrophoretic material EM comprises charged particles PA which are moveable in a suspension under influence of an electrical field generated by the electrodes RE, GE, DE. In FIG. 1, by way of example, all the particles are gathered in the reservoir volume above the reservoir electrode RE.

FIG. 2 shows schematically an electrode arrangement for four pixels of an in-plane electrophoretic passive matrix display. While FIG. 1 is a side view of the pixel P, FIG. 2 shows a top-view of four of the pixels. The reservoir electrodes RE, which extend in the column direction and have protrusions in the row direction, may be interconnected to receive a common reservoir voltage VR for all the pixels P. Also the display electrodes DE1 and DE2 extend in the column direction and have a square protrusion per pixel in the row direction. The display electrode DE1 receives the display voltage VD1, and the display electrode DE2 receives the display voltage VD2. The gate electrodes GE1 and GE2 extend in the row direction in-between the protrusions of the reservoir electrodes RE and the protrusions of the display electrodes DE1, DE2. The voltage VG1 and VG2 are supplied to the gate electrodes GE1 and GE2, respectively.

It has to be noted that the pixels P shown in FIGS. 1 and 2 are very specific embodiments only. The orientation of the pixels P may be different, for example, the top and bottom, and/or the row and column directions may be interchanged. The substrate SU2 may not be required. The protrusions of the gate electrodes GE and the display electrodes DE may interleave multiple times in a same pixel. The walls W may be arranged around a group of pixels P. The shape and size of the pixels P may be different.

Usually, the reservoir volume is smaller than the display volume. Further, usually the particles PA in the reservoir volume are shielded from a viewer, and the optical state of the pixel P is determined by the number of particles PA present in the display volume above the display electrode DE. In prior art drive methods of the pixels, which are shown in FIG. 1, during a reset phase suitable voltage levels are supplied to the reservoir electrodes RE, the gate electrodes GE and the display electrodes DE such that the charged particles PA are attracted towards the reservoir volume where they all gather. The actual voltages supplied to the electrodes RE, GE, DE depend on the type of electrophoretic material used and on the dimensions of the electrodes and other elements of the pixel. During the writing phase the levels of the voltages on the electrodes RE, GE, DE are selected such that all or part of the particles PA are moved from the reservoir volume to the display volume.

The gate electrodes GE are required in passive matrix displays to introduce a threshold per pixel P. In active matrix displays the TFTs enable to selectively select the pixels P and the gate electrodes GE are not required.

With respect to FIG. 2, the electrical field generated by the voltages VR, VG1, VG2 and VD1, VD2 during the writing phase wherein the particles PA are moved from the reservoir volume to the display volume is typically strongly inhomogeneous and limited to an area very close to the electrodes. In the case of rather large pixels P (for example 500*500 μm), the electrical field at the side of the display electrode DE where no gap is present is insufficient to induce particle movement. This leads to a problem when the pixel P has to be cleared as these particles PA cannot be sufficiently transferred from the display electrode DE to the reservoir electrode RE. For example, if the particles PA are positively charged and the voltages VD1, VG and VR1 are 0V, −30V and −45V Volts, respectively, are applied during 70 seconds, only a small region above the display electrode DE near the gate electrode GE is cleared. The particles PA outside this region stay above the display electrode DE and thus are not transferred to the reservoir volume. Waiting for a longer period of time does not result in the transfer of more particles PA to the reservoir volume.

It appears that there are two reasons why it is especially difficult to achieve good clearing of the display volume. Firstly, when clearing, the particles PA have to be compressed onto the reservoir electrode RE. This requires higher fields than the decompression or filling of the display volume. Secondly, when all particles PA are spread over the display electrode DE, then they are far away from the gap between the display electrode DE and the gate electrode GE. Since the electrical field drops rapidly with the distance from the gap, it is more difficult to transfer particles PA from the far side of the display electrode DE.

FIGS. 3A and 3B show signals for driving the electrodes of an in-plane electrophoretic display as shown in FIG. 2, for positively charged particles. FIG. 3A shows the voltage VR supplied to the reservoir electrode RE during the write period. FIG. 3B shows the voltage VG supplied to the gate electrode GE during the write period. The voltage on the display electrode DE is zero volts. The voltage VR comprises pulses with consecutive levels of −15V and −45V. The voltage VG comprises pulses with consecutive levels of 0V and −30V. During the first period in time T1, both the voltages VR and VG comprise at least one pulse with a period duration T11. During the second period in time T2, both the voltages VR and VG comprise at least one pulse with a period duration T21 which is shorter than the period duration T11. During the third period in time T3, both the voltages VR and VG comprise at least one pulse with a period duration T31 which is shorter than the period duration T21. During the fourth period in time T4, both the voltages VR and VG comprise at least one pulse with a period duration T41 which is shorter than the period duration T31.

In the example shown in FIGS. 3A and 3B, the periods in time T1, T2, T3 and T4 all have the same duration of 20 seconds. The period durations T11, T21, T31 and T41 are 400 ms, 200 ms, 100 ms and 50 ms. In accordance with the present invention, shaking voltages are superimposed on the fixed DC voltage levels required to obtain the DC-offset voltage. The DC-offset voltage used in the prior art creates the electrical field for pulling the particles PA from the display volume to the reservoir volume. In accordance with the present invention, the DC-offset voltage is modulated to obtain the pulses which are also referred to as shaking pulses because these shake the particles PA to increase their mobility. At first the frequency of the pulses is selected to allow the particles PA to transverse across a considerable portion of the display electrode DE. Thus, the period duration T11 of the pulses should be sufficiently long to move the particles PA to and fro across a considerable portion of the display electrode DE. This loosens any particles PA trapped on the far side of the display electrode DE. The frequency of the superimposed voltage is slowly increased which results in the DC-offset voltage having a dominant effect and the particles PA are collected in the reservoir volume. The shorter the period duration of the pulses becomes, the less time is available for the particles PA to respond to the levels of the pulses and the shorter the distance is the particles PA will oscillate around the average position. But, due to the turbulence as a result of charge transfer processes occurring at the electrodes, also the particles PA at the far edge of the display electrode DE are loosened and will be pulled to the next average position during the next period T2. The turbulence may occur due to the fluidic medium which is set in motion. This motion travels through the pixel, thereby loosening particles. Now, due to the shorter duration T21 of the pulses, the oscillation of the particles PA around their average position is less, and so on. In the end all the particles PA are near to the gap between the display electrode DE and the gate electrode GE and thus the DC-offset voltage between the display electrode DE and the gate electrode GE is able to pull all the particles PA to the reservoir volume.

FIG. 4 shows schematically an electrode arrangement for a pixel of an in-plane electrophoretic display. Now the pixel comprises five parallel arranged electrodes E1, E2, E3, E4 and E5 to create an electrical field in the electrophoretic material. In this context, the term pixel does not indicate that this construction can only be used in a display. Other uses can be envisaged, such as a micro-fluidic device containing biological particles or an optical shutter device. Thus, the term pixel may also be read as cell. It will be elucidated with respect to FIGS. 5A and 5B how to optimally transfer particles PA present above the middle electrode E3 to the electrode E4. These electrodes may be controlled in an active matrix like manner. Although FIG. 4 shows five parallel arranged electrodes E1, E2, E3, E4 and E5, an active matrix drive of two parallel arranged electrodes operates in the same manner.

FIGS. 5A and 5B show signals for driving the electrodes of an in-plane electrophoretic display as shown in FIG. 4. FIG. 5A shows the voltage V3 on the electrode E3, and FIG. 5B shows the voltage V4 on the electrode E4. The voltages shown in FIGS. 5A and 5B are found to be practical values for a display in which the pixels are formed by micro-cups of 200 by 200 microns, and have a height of 10 microns. The micro-cups are filled with negatively charged Carbon Black particles PA (with 1-2 micron diameter). The five ITO electrodes E1 to E5 are located on the bottom of the micro-cup. Such a five electrode topology allows transporting particles over a longer distance than in a two electrode topology.

The particles PA which are initially located on the middle electrode E3 should all be moved to the electrode E4. If in accordance with the prior art drive method fixed DC potentials of +10V on the electrode E3 and +200V on the electrode E4 are applied while the other electrodes E1, E2 and E5 are on 0V, it is expected that all the particles PA are attracted to the electrode E4. Indeed, after 120 ms roughly half of the particles PA are transferred. However, after that, the transfer diminishes, and after a few seconds the transfer ceases. This results in an incomplete transfer of particles PA, which limits the optical performance of the cell.

The reason for this incomplete transfer is that the electric fields generated in the in-plane electrophoretic display are not homogenous and concentrate near the edges of the electrodes. This effect is even enhanced due to screening effects of the particles PA itself and the (invisible) counter ions. The particles PA and ions that have been transferred reduce the magnitude of the remaining electric fields, especially above the central region of the electrodes where stray fields from the edges are weak. Since the remaining particles PA no longer feel an electric force, there is no movement of these particles PA. The effect of supplying the fixed constant DC potentials on the movement of the particles is illustrated in FIG. 6A.

According to the present invention, with a “shaking” drive, in which pulses are used, all particles PA can be transferred. The effect of supplying the pulse signals on the movement of the particles PA is illustrated in FIG. 6B, for the same cell as in FIG. 6A and with the same maximum applied electric fields (thus, the same drivers can be used). The difference is that after one second, when the transfer is more or less saturated, the applied voltages are modulated, from +10V on the middle electrode E3 and +200V on the electrode E4, to +120V on the middle electrode E3 and +100V on the electrode E4. In this example, both the magnitude and the sign of the applied potential difference are modulated (from +190V to −20V). This ensures that the particles PA and ions that have accumulated at the electrodes E3, E4 (and are responsible for screening) are no longer strongly attracted by the electrodes E3, E4 and have the opportunity to reassemble and better spread across the electrode area (and be less capable of screening). The pulses have one level which is identical to the prior art DC potential. The other levels are selected such that an electric field is generated in the opposite direction to move the particles in the opposite direction than during the preceding levels which are identical to the prior art levels. Thus, the voltage V3 starts with 10V at the instant t10 and changes to 120V at the instant t11 to return to 10V at the instant t12, and so on. The voltage V4 starts at 200V at the instant t10 and changes to 100V at the instant t11 to return to 200V at the instant t12, and so on. In a practical implementation, the duration T10, T11, T12, T13, T14 and T15 of the levels of the pulses may be 1 second.

It has to be noted that in this example, both the magnitude and sign of the resulting voltage between the electrodes E3 and E4 are modulated. However, by modulating the magnitude only, it is also possible to achieve a better spread of the particles PA across the electrode area. Because, for all charged particles PA their distribution close to an attracting electrode is governed by the balance between electric forces and diffusion. For high electric fields their distribution will be narrow close to the attracting electrode. When reducing the electric field, the diffusion of the particles will result in a drive away from the electrode, until the balance is restored again, but now with a broader distribution.

FIGS. 6A and 6B, respectively illustrate the movement of the particles in the display shown in FIG. 4 with a prior art drive and with a drive in accordance with the signals shown in FIGS. 5A and 5B.

FIG. 6A shows images from left to right which illustrate how the particles PA are only partly transferred from the electrode E3 to the electrode E4 of the pixel P. In total, six different optical states of the pixel P are shown with progressing time from left to right. The arrows between the optical states shown indicate the time-order. The fixed DC voltages of 10 V and 200V which are supplied to the electrodes E3 and E4, respectively, are shown on top op the images. In the left most image, all the particles PA are located above the electrode E3. In the next image a few particles have been transferred to above the electrode E4. But, this transferring process stops and after a long time, as indicated by the right most image, still not all particles PA are moved from above the electrode E3 to the above the electrode E4.

FIG. 6B shows with the arrows between the images how the particles move from the electrode E3 to the electrode E4 of the pixel P in time. The pulse voltage levels which are supplied to the electrodes E3 and E4 are shown on top op the images. The left most image I1 shows the starting situation wherein all the particles PA are located above the middle electrode E3 and the voltages V3 and V4 are changed from zero to 10V and 200V, respectively. The particles PA start to move towards the electrode E4. The image I2 shows the next optical state in time wherein the voltages V3 and V4 are still 10V and 200V, respectively. Now part of the particles PA has been moved to the electrodes E4. In particular the particles PA above the right hand section of electrode E3 are transferred to the electrode E4. The image I3 shows the next optical state wherein the voltages V3 and V4 are 120V and 100V, respectively. The particles PA on the electrode E3 have reassembled across the electrode and again populate the right hand section of the electrode E3. The image 14 shows the next optical state in time wherein the voltages V3 and V4 are again 10V and 200V, respectively. Now again the particles PA of the right hand section of the electrode E3 are moved to the electrodes E4. The total number of particles moved is larger than in image I2. The image I5 shows the next optical state wherein the voltages V3 and V4 are 120V and 100V, respectively. Again the right hand section of the electrode E3 is populated by particles PA. This process is repeated a few times, and gives rise to a step by step net movement of the particles PA to the electrode E4 until in the last image I10 all particles PA are located above the electrode E4.

FIGS. 7A to 7G show examples of the voltage difference between two electrodes in accordance with the present invention. The voltage difference between the first and the second electrodes is denoted by DV. All pulse trains of this voltage difference, which is the voltage over the moving particle material, have a non-zero average level. The voltage difference is the result of the levels of the first en the second voltage. These pulse trains are more in general referred to as a sequence of predetermined levels (indicating the voltage levels) with each a predetermined duration. What is relevant to the present invention is that in this sequence of levels the levels are selected such that the electrical field across the material has a polarity which is changed a plurality of times. This need not happen between every successive pair of levels but at least a few times during the transition period such that the particles are moved in opposite directions during levels which cause different polarities of the electrical field. As elucidated earlier, it is this to and fro movement which improves the speed and completeness of the particle movement when changing the optical state of the material. The duration of the levels is selected sufficiently long such that at least part of the particles actually moves, and thus the optical state indeed changes. Further, the average value of the levels of one of the voltages or both the first and the second voltages should be non-zero such that the particles will have a net movement in the direction of the electrical field caused by the average non-zero voltage across the moving particle material.

In all the FIGS. 7A, 7B, 7C, 7E, 7F and 7G it is, by way of example only, assumed that the particles move in the desired net movement direction when the difference voltage is has a positive level, and that the particles move opposite to the net movement direction if the difference voltage has a negative level. In FIG. 7D it is assumed, again by way of example only, that the particles move in the desired net movement direction when the difference voltage is has the highest positive level shown and that the particles move in the direction opposite to the net movement direction when the difference voltage has the lowest positive level shown.

FIG. 7A shows pulses with an increasing frequency as was already elucidated in more detail with respect to FIGS. 3A and 3B.

FIG. 7B shows pulses with a fixed frequency and a decreasing duration of the negative level. Alternatively, the positive level may have a decreasing level. In fact, the duration that the particles are moved in the opposite direction with the desired net movement is gradually decreasing.

FIG. 7C shows pulses with a fixed frequency of which the amplitude decreases. The frequency and amplitude are selected such that the high amplitude pulses are able to move the particles between the two electrodes to an amount that the optical state changes between successive pulse levels. The decreasing amplitude of the pulses causes to reach in the end the optical state defined by the average level of the pulses.

FIGS. 7D, 7E and 7F show pulses with a fixed frequency and amplitude. The embodiment shown in FIG. 7E has been discussed in more detail with respect to FIGS. 5A and 5B. FIG. 7D illustrates that it is not absolutely required that the voltage difference DV over the moving particle material EM changes polarity. What counts is that the particles move in opposite directions. A part of the electrical field which moves the particles in the direction opposite to the net movement direction may be caused by the high concentration of the particles itself. FIG. 7F illustrates that the voltage difference level during the periods in time the particles move in the direction opposite to the desired net movement direction is higher than the voltage level during the periods in time the particles move in the net movement direction.

FIG. 7G shows levels which form a staircase like difference voltage. Now, adjacent levels may still move the particles in the same direction. But, the levels are selected such that a plurality of times the movement of the particles changes direction.

FIG. 8 shows a block diagram of a display apparatus. A signal processing circuit SP receives an input signal IV, which represents an image to be displayed on the in-plane driven electrophoretic device DP, to supply the output signal OS to the driver DR. The driver DR supplies drive signals DS to the in-plane electrophoretic device DP.

It should be noted that the above-mentioned embodiments illustrate rather than limit the invention, and that those skilled in the art will be able to design many alternative embodiments without departing from the scope of the appended claims.

For example, although most embodiments in accordance with the invention are described with respect to an electrophoretic display, the invention is also suitable for electrophoretic displays in general and, even more general, for bi-stable displays. A bi-stable display is defined as a display that the pixel (Pij) substantially maintains its grey level/brightness after the power/voltage to the pixel has been removed. Alternatively the device can be a moving particle device, for example a micro-fluidic device containing charged biological particles (DNA or proteins, which are not at their iso-electrical point). A capture site could be placed on one of the electrodes and the driving so chosen to attract all charged particles of a particular charge to said capture site.

Usually, an E-ink display comprises white and black particles which allow obtaining the optical states white, black and intermediate grey states. If the particles have other colors than white and black, still, the intermediate states may be referred to as grey scales.

Bi-stable display panels can form the basis of a variety of applications where information may be displayed, for example in the form of information signs, public transport signs, advertising posters, pricing labels, billboards etc. In addition, they may be used where a changing non-information surface is required, such as wallpaper with a changing pattern or color, especially if the surface requires a paper like appearance.

The present invention is not limited by the given values of the voltages and modulation frequency. In general, however, the frequency of the modulation should be chosen in combination with the geometry of the electrodes to allow for a net effective displacement of the particles. If the frequency is too high then the particles do not have sufficient time to transverse a significant portion of the gap between the electrodes and shaking can only help to avoid aggregation. If, however, the frequency is too low then all the particles that are moved in one direction by one level of the pulse are simply pulled back by the successive level of the pulse.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A driver for an in-plane driven moving particle device comprising a first substrate (SU1) and a moving particle material (EM) comprising charged particles (PA), a first electrode (RE) and a second electrode (GE; DE), both arranged for generating an in-plane electrical field in the moving particle material (EM), wherein the in-plane electrical field is directed predominantly in parallel with a surface of the first substrate (SU1), the driver (DR) being constructed for supplying, during a transition phase wherein an optical state of the moving particle material (EM) has to change, a first voltage (VR) to the first electrode (RE), and a second voltage (VG; VD1) to the second electrode (GE; DE), wherein both the first voltage (VR) and the second voltage (VG; VD1) comprise a sequence of a plurality of predetermined levels having predetermined durations, and wherein the first voltage (VR) and/or the second voltage (VG; VD1) have a non-zero average level, and wherein said levels, said durations and said average level are selected for allowing at least part of the particles (PA) to move between the first electrode (RE) and second electrode (GE; DE) in opposite directions to change the optical state a plurality of times in opposite directions during the sequence, and to obtain a net movement of the particles during the transition phase in a direction of an electrical field caused by the average level.

2. A driver as claimed in claim 1, wherein the transition phase is a writing phase, an erasing phase, or a reset phase.

3. A driver as claimed in claim 1, being constructed for supplying successive ones of the levels of the first voltage (VR) and/or the levels of the second voltage (VG; VD1) to invert a direction of the electrical field between the first electrode (RE) and the second electrode (GE; DE).

4. A driver as claimed in claim 3, wherein said successive levels have different signs.

5. A driver as claimed in claim 1, wherein the driver is constructed for generating the levels of the first voltage (VR) and the levels of the second voltage (VG; VD1) such that a first electrical field caused by the levels when supplied for moving the particles in a direction of the net movement of the particles during the transition phase is smaller than a second electrical field caused by the levels when supplied for moving the particles in a direction opposite to the direction of the net movement.

6. An in-plane driven moving particle device comprising:
a first substrate (SU1) and a moving particle material (EM) comprising charged particles (PA),
a first electrode (RE) and a second electrode (GE; DE), both arranged for generating an in-plane electrical field in the moving particle material (EM), wherein the in-plane electrical field is directed predominantly in parallel with a surface of the first substrate (SU1), and
a driver (DR).

7. An in-plane driven moving particle device as claimed in claim 6, wherein the moving particle device is an electrophoretic display (DP) with pixels each comprising an associated first electrode (RE) and second electrode (GE; DE).

8. An in-plane driven moving particle device as claimed in claim 6, wherein the electrophoretic display further comprises a second substrate (SU2) opposing the first substrate (SU1), and wherein the electrophoretic material (EM) is sandwiched in-between the first substrate (SU1) and the second substrate (SU2), and wherein the first substrate (SU1) and/or the second substrate (SU2) is transparent.

9. An in-plane driven moving particle device as claimed in claim 6, wherein the first electrode (RE) is a reservoir electrode, the first voltage (VR) is a reservoir voltage, the second electrode (GE) is a gate electrode, the second voltage (VG1) is a gate voltage, and wherein the device further comprises a display electrode (DE), the gate electrode (GE) being arranged in-between the reservoir electrode (RE) and the display electrode (DE), and wherein the levels, the durations and the average level are selected for allowing the particles (PA) to cross the gate electrode (GE).

10. An in-plane driven moving particle device as claimed in claim 9, wherein the driver (DR) is constructed for supplying levels having a duration decreasing during the transition phase from a start value at which the particles (PA) have sufficient time to move between the reservoir electrode (RE) and the display electrode (DE) to an end value at which a movement of the particles (PA) is predominantly determined by the average level between the reservoir electrode (RE) and the gate electrode (GE).

11. An in-plane driven moving particle device as claimed in claim 9, wherein the driver (DR) is constructed for supplying levels having decreasing values during the transition phase from a start value at which the particles (PA) are moved a substantial distance between the reservoir electrode (RE) and the display electrode (DE) to an end value at which a movement of the particles (PA) is predominantly determined by the average level between the reservoir electrode (RE) and the gate electrode (GE).

12. A display apparatus comprising
the in-plane driven moving particle device as claimed in claim 6, and
a signal processing circuit (SP) for receiving an input signal (IV) representing an image to be displayed on the in-plane driven moving particle device (DP) and for supplying at least one output signal (OS) to the driver (DR).

13. A method of driving an in-plane moving particle device comprising a first substrate (SU1) and a moving particle material (EM) comprising charged particles (PA), and a first electrode (RE) and a second electrode (GE; DE), both arranged for generating an in-plane electrical field in the moving particle material (EM), wherein the in-plane electrical field is directed predominantly in parallel with a surface of the first substrate (SU1), the method comprises supplying (DR), during a transition phase wherein an optical state of the moving particle material (EM) has to change, a first voltage (VR) to the first electrode (RE), and a second voltage (VG; VD1) to the second electrode (GE; DE), wherein both the first voltage (VR) and the second voltage (VG; VD1) comprise a sequence of a plurality of predetermined levels having predetermined durations, and wherein the first voltage (VR) and/or the second voltage (VG; VD1) have a non-zero average level, and wherein the levels, the durations and said average level are selected for allowing the particles (PA) to move between the first electrode (RE) and second electrode (GE; DE) in opposite directions to change the optical state a plurality of times in opposite directions during the sequence, and to obtain a net movement of the particles (PA) during the transition phase in a direction of an electrical field caused by the average level.
